(19) United States
(12) Patent Application Publication
(10) Pub. No.: US 2024/0427165 A1
(43) Pub. Date: Dec. 26, 2024

(54) OPTICAL DIFFRACTION ELEMENT AND POSITION ADJUSTMENT METHOD FOR OPTICAL DIFFRACTION ELEMENT

(71) Applicant: Fujikura Ltd., Tokyo (JP)

(72) Inventors: Hiroyuki Kusaka, Tokyo (JP); Masahiro Kashiwagi, Tokyo (JP)

(73) Assignee: Fujikura Ltd., Tokyo (JP)

(21) Appl. No.: 18/262,911

(22) PCT Filed: Dec. 8, 2021
(86) PCT No.: PCT/JP2021/045042

§ 371 Date: Jul. 25, 2023

(30) Foreign Application Priority Data
Feb. 18, 2021 (JP) 2021-024502

(51) Int. Cl. G02B 27/42; G02F 3/00; G06E 1/00

(52) U.S. Cl. CPC G02B 27/4233; G02F 3/00; G06E 1/00

(57) ABSTRACT

A method includes inputting, via a first position adjustment optical structure, adjustment signal light into a second position adjustment optical structure. A first light diffraction element of an optical computing device includes a first computing optical structure constituted by microcells, and the first position adjustment optical structure. A second light diffraction element of the optical computing device includes a second computing optical structure constituted by microcells, and the second position adjustment optical structure. The method includes adjusting, based on the adjustment signal light outputted from the second position adjustment optical structure, a position of the second light diffraction element with respect to the first light diffraction element.

### BACKGROUND

### Technical Field

The present invention relates to a light diffraction element having an optical computing function. Further, the present invention relates to a method for adjusting a position of a light diffraction element in an optical computing device that includes such a light diffraction element.

### Description of the Related Art

Known is a light diffraction element that includes a plurality of microcells each of which has an individually set thickness and that optically performs predetermined computing by causing mutual interference of light beams which have passed through the respective microcells. Optical computing performed with use of a light diffraction element has an advantage of achieving higher speed and lower electric power consumption as compared with electrical computing performed with use of a processor. Patent Literature 1 discloses an optical neural network which has an input layer, an intermediate layer and an output layer. The light diffraction element described above can be used as, for example, an intermediate layer of such an optical neural network.

### PATENT LITERATURE

Patent Literature 1: U.S. Pat. No. 7,847,225

In order to perform advanced optical computing, a plurality of light diffraction elements used are aligned such that light outputted from an n-th light diffraction element is inputted to an n+1-th light diffraction element. In this case, inaccurate adjustment of a position of the n+1-th light diffraction element with respect to the n-th light diffraction element makes it impossible to perform predetermined optical computing. Thus, highly accurate adjustment of a position of the n+1 light diffraction element with respect to the n-th light diffraction element is required in order to achieve an optical computing device that performs advanced optical computing.

### SUMMARY

One or more embodiments provide a position adjustment method that makes it possible, in an optical computing device including at least first and second light diffraction elements, to accurately adjust a position of the second light diffraction element with respect to the first light diffraction element.

A method in accordance with one or more embodiments is a method for adjusting a position of a second light diffraction element with respect to a first light diffraction element, in an optical computing device including the first light diffraction element and the second light diffraction element, the first light diffraction element including (a) a first computing optical structure constituted by a plurality of microcells and (b) a first position adjustment optical structure formed inside or outside the first computing optical structure, the second light diffraction element including (c) a second computing optical structure constituted by a plurality of microcells and (d) a second position adjustment optical structure formed inside or outside the second computing optical structure. The position adjustment method according to one or more embodiments employs a configuration such that the method includes the step of (i) inputting adjustment signal light into the second position adjustment optical structure via the first position adjustment optical structure and (ii) adjusting, with reference to the adjustment signal light that is outputted from the second position adjustment optical structure, a position of the second light diffraction element with respect to the first light diffraction element.

A light diffraction element in accordance one or more embodiments includes: a computing optical structure constituted by a plurality of microcells; and a position adjustment optical structure formed inside or outside the computing optical structure.

According to one or more embodiments, it is possible to provide a position adjustment method that makes it possible to accurately adjust a position of a second light diffraction element with respect to a first light diffraction element.

### BRIEF DESCRIPTION OF THE DRAWINGS

FIG. 1 is a plan view illustrating a configuration of a light diffraction element in accordance with one or more embodiments.

FIG. 2 is a perspective view illustrating an enlarged portion of a computing optical structure that is included in the light diffraction element illustrated in FIG. 1.

FIG. 3 is a perspective view illustrating a configuration of an optical computing device in accordance with one or more embodiments.

### DESCRIPTION OF THE EMBODIMENTS

### Configuration of Light Diffraction Element

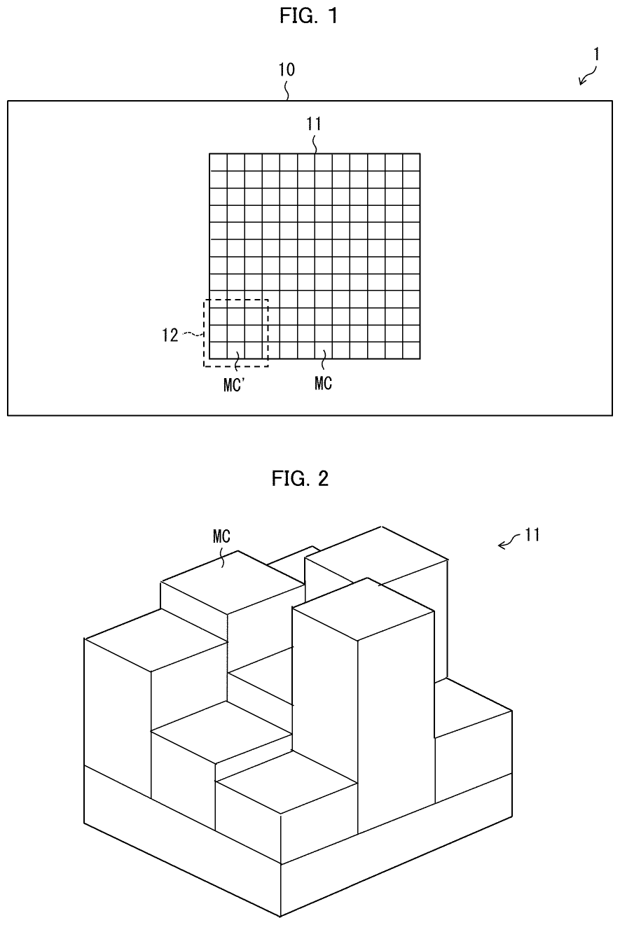

With reference to FIG. 1, the following will describe a configuration of a light diffraction element 1 in accordance with one or more embodiments. FIG. 1 is a plan view illustrating a configuration of the light diffraction element 1.

The light diffraction element 1 is a light-transmissive plate-like member and, as illustrated in FIG. 1, includes: a substrate 10; a computing optical structure 11 formed on a first main surface of the substrate 10; and a position adjustment optical structure 12 formed on a first main surface or second main surface (that is a main surface located on an opposite side to the first main surface) of the substrate 10. Each of the substrate 10, the computing optical structure 11, and the position adjustment optical structure 12 may be made of, for example, glass (for example, quartz glass) or may be made of resin (for example, photo-curable resin).

The position adjustment optical structure 12 is formed inside or outside the computing optical structure 11. Here, the expression “the position adjustment optical structure 12 is formed inside the computing optical structure 11” means that a part of the computing optical structure 11 functions also as the position adjustment optical structure 12. In addition, the expression “the position adjustment optical structure 12 is formed outside the computing optical structure 11” means, for example, that: in a case where the position adjustment optical structure 12 is formed on the first main surface of the substrate 10, the position adjustment optical structure 12 is formed in an area other than an area in which the computing optical structure 11 is formed on the first main surface; and in a case where the position adjustment optical structure 12 is formed on the second main surface of the substrate 10, the position adjustment optical structure 12 is formed such that an area where the computing optical structure 11 is formed on the first main surface differs from an area, on the first main surface, of an orthogonal projection of an area in which the position adjustment optical structure 12 is formed on the second main surface. FIG. 1 illustrates the light diffraction element 1 in which the position adjustment optical structure 12 is formed inside the computing optical structure 11.

The computing optical structure 11 is an optical structure configured to perform predetermined optical computing. The computing optical structure 11 can be constituted by, for example, a plurality of microcells MC that have respective thicknesses or refractive indices which are set independently of each other. When signal light is inputted to the computing optical structure 11, signal light beams that have been diffracted by the respective microcells MC interfere with each other, so that predetermined optical computing is performed. An intensity distribution of the signal light outputted from the computing optical structure 11 shows a result of the optical computing.

Here, the term “microcell” means, for example, a cell having a cell size of less than 10 μm. The term “cell size” refers to a square root of an area of a cell. For example, in a case where a microcell has a square shape in plan view, the cell size is a length of one side of the cell. The cell size has a lower limit that is not particularly limited but may be, for example, 1 nm.

The computing optical structure 11 illustrated in FIG. 1 is constituted by 12×12 microcells MC that are arranged in a matrix manner. The shape of each of the microcells MC in plan view is, for example, a square with a size of 1 μm×1 μm, and the shape of the computing optical structure 11 in plan view is, for example, a square with a size of 12 μm×12 μm.

The light beams that pass through the respective microcells MC can have phase-shift amounts that are set independently of each other by (i) setting the thicknesses of the respective microcells MC independently of each other or (ii) selecting the refractive indices of the respective microcells MC independently of each other. One or more embodiments employ the method (i), which can be performed by nanoimprinting. In this case, as illustrated in FIG. 2, each of the microcells MC is constituted by a pillar that has a quadrangular prism shape and that has a square bottom surface which has sides each having a length equal to the cell size. In this case, a phase-shift amount of light that passes through a microcell MC is determined in accordance with a height of the pillar. That is, the light that passes through the microcell MC constituted by a high pillar has a large phase-shift amount, and the light that passes through the microcell MC constituted by a low pillar has a small phase-shift amount.

Note that the thickness or the refractive index of each of the microcells MC can be set, for example, through machine learning.

A model used in this machine learning can be, for example, a model to which the intensity distribution of the signal light inputted to the computing optical structure 11 is inputted and from which the intensity distribution of the signal light outputted from the computing optical structure 11 is outputted and which includes, as a parameter, the thickness or the refractive index of each of the microcells MC. Here, the intensity distribution of the signal light inputted to the computing optical structure 11 means, for example, a set of numerical values indicative of intensities of signal light beams which are inputted to the respective microcells MC constituting the computing optical structure 11. In addition, the intensity distribution of the signal light outputted from the computing optical structure 11 means, for example, a set of numerical values indicative of intensities of signal light beams which are inputted to respective microcells constituting a computing optical structure of another light diffraction element that is disposed so as to follow the light diffraction element 1 or a set of numerical values indicative of intensities of signal light beams which are inputted to respective cells of a light receiving device (for example, a two-dimensional image sensor) that is disposed so as to follow the light diffraction element 1.

The position adjustment optical structure 12 is an optical structure for adjusting a position of the light diffraction element 1 with respect to another light diffraction element that is disposed so as to precede or follow the light diffraction element 1. The position adjustment optical structure 12 can be constituted by, for example, a plurality of microcells MC' each of which has a thickness, refractive index, or transmittance that is independently set.

For example, the position adjustment optical structure 12 may be used to form an optical image having a specific intensity distribution on a position adjustment optical structure of another light diffraction element that is disposed so as to follow the light diffraction element 1. Such a position adjustment optical structure 12 can be achieved, for example, by setting thicknesses of the respective microcells MC' so that the position adjustment optical structure 12 has a function equivalent to that of a condenser lens having a specific shape.

Alternatively, the position adjustment optical structure 12 may be used to change an intensity distribution of an optical image which has been formed by a position adjustment optical structure of another light diffraction element that is disposed so as to precede the light diffraction element 1. This change is made in accordance with a position of the light diffraction element 1 with respect to the another light diffraction element. Such a position adjustment optical structure 12 can be achieved, for example, by setting transmittances of the respective microcells MC' so that the position adjustment optical structure 12 has a function equivalent to that of a mask having a specific shape.

The configuration in which the position adjustment optical structure 12 is provided inside the computing optical structure 11 disadvantageously limits the content of the optical computing that is performed by the computing optical structure 11 but advantageously makes it easy to reduce a size of the light diffraction element 1. However, such limitation on the content of the computing that is performed by the computing optical structure 11 can be sufficiently reduced by providing the position adjustment optical structure 12 in a peripheral portion (which is, for example, any one of four corner portions of the computing optical structure 11 in a case where the shape of the computing optical structure 11 in plan view is quadrangular) that is a portion of the computing optical structure 11 and that is unlikely to be used for optical computing. In contrast, the configuration in which the position adjustment optical structure 12 is formed outside the computing optical structure 11 disadvantageously makes it difficult to reduce the size of the light diffraction element 1 but advantageously causes no limitation on the content of the computing that is performed by the computing optical structure 11.

### Configuration of Optical Computing Device and Flow of Optical Computing

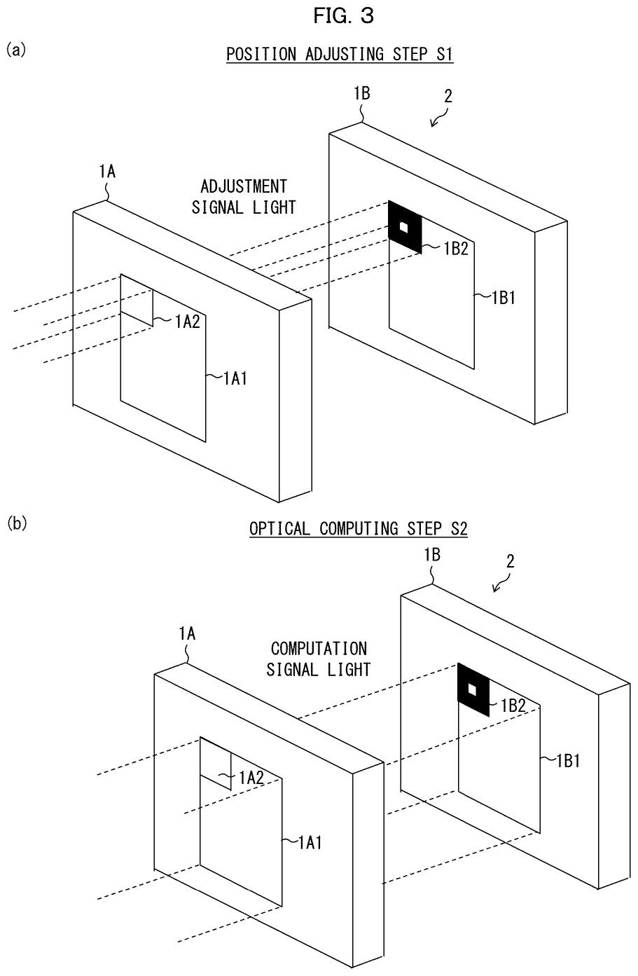

With reference to FIG. 3, the following will describe: a configuration of an optical computing device 2 in accordance with one or more embodiments; and a flow of an optical computing method using the optical computing device 2. Each of (a) and (b) of FIG. 3 is a perspective view illustrating the configuration of the optical computing device 2, (a) of FIG. 3 shows how a position adjusting step is performed, and (b) of FIG. 3 shows how an optical computing step is performed.

As illustrated in FIG. 3, the optical computing device 2 includes a first light diffraction element 1A and a second light diffraction element 1B that is disposed so as to follow the first light diffraction element 1A. Each of these two light diffraction element 1A and 1B is one example of the light diffraction element 1 described above.

The first light diffraction element 1A includes a first position adjustment optical structure 1A2 inside a first computing optical structure 1A1. The second light diffraction element 1B includes a second position adjustment optical structure 1B2 inside a second computing optical structure 1B1.

The optical computing method includes a position adjusting step S1 (which is one example of “method for adjusting a position (position adjustment method)” described in Claims) and an optical computing step S2. As illustrated in (a) of FIG. 3, the position adjusting step S1 is a step of (i) inputting adjustment signal light having a specific intensity distribution to the second position adjustment optical structure 1B2 via the first position adjustment optical structure 1A2 and (ii) adjusting, with reference to the adjustment signal light outputted from the second position adjustment optical structure 1B2, a position of the second light diffraction element 1B with respect to the first light diffraction element 1A. The optical computing step S2 is a step of (iii) inputting, into the second computing optical structure 1B1 via the first computing optical structure 1A1, computation signal light having an intensity distribution indicative of an input signal and (iv) acquiring, as an intensity distribution indicative of an output signal (result of the computing), an intensity distribution of signal light outputted from the second computing optical structure 1B1. The optical computing step S2 is performed after the position adjusting step S1. The adjustment signal light and the computation signal light may have the same wavelength or may have different wavelengths.

In the position adjusting step S1, when adjustment signal light having a specific intensity distribution is inputted to the first position adjustment optical structure 1A2, the first position adjustment optical structure 1A2 is used to form an optical image having a specific intensity distribution on the second position adjustment optical structure 1B2. The second position adjustment optical structure 1B2 is used to change, in accordance with a position of the second light diffraction element 1B with respect to the first light diffraction element 1A, the intensity distribution of the optical image that has been formed by the first position adjustment optical structure 1A2. The position of the second light diffraction element 1B with respect to the first light diffraction element 1A can be set appropriate by adjusting the position of the second light diffraction element 1B with respect to the first light diffraction element 1A so that the optical image detected with use of an image sensor that is disposed so as to follow the second position adjustment optical structure 1B2 has an intensity distribution that is identical to a predetermined intensity distribution.

In one or more embodiments, the first position adjustment optical structure 1A2 serves as a condenser lens for concentrating adjustment light on a center portion of the second position adjustment optical structure 1B2. In addition, in one or more embodiments, the second position adjustment optical structure 1B2 serves as a mask that transmits the adjustment light incident on the center portion of the second position adjustment optical structure 1B2 and that blocks (absorbs or reflects) the adjustment light incident on a peripheral portion of the second position adjustment optical structure 1B2. Thus, a shift of the position of the second light diffraction element 1B from an appropriate position decreases an intensity of the adjustment light passing through the second position adjustment optical structure 1B2. Further, diffraction light is generated in a direction in which the position of the second light diffraction element 1B shifts from the appropriate position. Therefore, monitoring the intensity distribution of the adjustment light passing through the second position adjustment optical structure 1B2 makes it possible to specify in which direction and to what degree the second light diffraction element 1B is shifted. Note that, in a case where the adjustment signal light and the computation signal light have different wavelengths, it is preferable that the microcells that function as a mask in the second position adjustment optical structure 1B2 block the adjustment signal light and transmit the computation signal light. This makes it possible to reduce the limitation imposed on the content of the computing that is performed by the second computing optical structure.

Note that the first light diffraction element 1A may be further provided with a position adjustment optical structure that is equivalent to the first position adjustment optical structure 1A2, and the second light diffraction element 1B may be further provided with a position adjustment optical structure that is equivalent to the second position adjustment optical structure 1B2. This makes it possible to adjust not only a translational shift in position of the second light diffraction element 1B with respect to the first light diffraction element 1A but also a rotational shift in angle of the second light diffraction element 1B with respect to the first light diffraction element 1A.

Note that the position adjusting step S1 described above may be performed by a manufacturer before the optical computing device 2 is shipped as a product or may be performed by a user after the optical computing device 2 has been shipped as a product.

Aspects of one or more embodiments can also be expressed as follows:

A position adjustment method according to Aspect 1 of one or more embodiments is a method for adjusting a position of a second light diffraction element with respect to a first light diffraction element, in an optical computing device including the first light diffraction element and the second light diffraction element, the first light diffraction element including (a) a first computing optical structure constituted by a plurality of microcells and (b) a first position adjustment optical structure formed inside or outside the first computing optical structure, the second light diffraction element including (c) a second computing optical structure constituted by a plurality of microcells and (d) a second position adjustment optical structure formed inside or outside the second computing optical structure. The position adjustment method according to Aspect 1 of one or more embodiments employs a configuration such that the method includes the step of (i) inputting adjustment signal light into the second position adjustment optical structure via the first position adjustment optical structure and (ii) adjusting, with reference to the adjustment signal light that is outputted from the second position adjustment optical structure, a position of the second light diffraction element with respect to the first light diffraction element.

According to the above configuration, it is possible to accurately adjust the position of the second light diffraction element with respect to the first light diffraction element.

A position adjustment method according to Aspect 2 of one or more embodiments employs, in addition to the configuration of Aspect 1, a configuration such that: the first position adjustment optical structure forms an optical image having a specific intensity distribution on the second position adjustment optical structure; and the second position adjustment optical structure changes, in accordance with the position of the second light diffraction element with respect to the first light diffraction element, the intensity distribution of the optical image that has been formed by the first position adjustment optical structure.

According to the above configuration, it is possible to more accurately adjust the position of the second light diffraction element with respect to the first light diffraction element.

A position adjustment method according to Aspect 3 of one or more embodiments employs, in addition to the configuration of Aspect 2, a configuration such that the second position adjustment optical structure includes a microcell that functions as a mask which blocks the adjustment signal light and that transmits computation signal light.

According to the above configuration, it is possible to sufficiently reduce limitation on the content of the computing that is performed by the second computing optical structure.

A position adjustment method according to Aspect 4 of one or more embodiments employs, in addition to the configuration of any one of Aspects 1 to 3, a configuration such that: the first position adjustment optical structure is formed inside the first computing optical structure; and the second position adjustment optical structure is formed inside the second computing optical structure.

According to the above configuration, it is possible to reduce a size of the first light diffraction element and a size of the second light diffraction element.

A position adjustment method according to Aspect 5 of one or more embodiments employs, in addition to the configuration of Aspect 4, a configuration such that: the first position adjustment optical structure is formed in a peripheral portion of the first computing optical structure; and the second position adjustment optical structure is formed in a peripheral portion of the second computing optical structure.

According to the above configuration, it is possible to sufficiently reduce the limitation on the content of the computing that is performed by the first light diffraction element and the second light diffraction element.

A light diffraction element according to Aspect 6 of one or more embodiments includes: a computing optical structure constituted by a plurality of microcells; and a position adjustment optical structure formed inside or outside the computing optical structure.

According to the above configuration, it is possible to provide a light diffraction element whose size is easily reduced and whose position can be accurately adjusted with respect to another light diffraction element that is disposed so as to precede or follow the light diffraction element.

A light diffraction element according to Aspect 7 of one or more embodiments includes two or more of the light diffraction elements according to Aspect 6 of one or more embodiments.

According to the above configuration, with use of the position adjustment optical structure that is provided in each of two light diffraction elements, it is possible to accurately adjust a position of one of the light diffraction elements with respect to the other one of the light diffraction elements.

### Additional Remarks

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 Light diffraction element
11 Computing optical structure
MC Microcell
12 Position adjustment optical structure
MC' Microcell
2 Optical computing device
1A First light diffraction element
1A1 First computing optical structure
1A2 First position adjustment optical structure
1B Second light diffraction element
1B1 Second computing optical structure
1B2 Second position adjustment optical structure
S1 Position adjusting step
S2 Optical computing step

1. A method comprising:
inputting, via a first position adjustment optical structure, adjustment signal light into a second position adjustment optical structure, wherein
a first light diffraction element of an optical computing device includes:
a first computing optical structure constituted by microcells; and
the first position adjustment optical structure; and
a second light diffraction element of the optical computing device includes:
a second computing optical structure constituted by microcells; and
the second position adjustment optical structure; and
adjusting, based on the adjustment signal light outputted from the second position adjustment optical structure, a position of the second light diffraction element with respect to the first light diffraction element.

2. The method according to claim 1 further comprising:
forming an optical image having a intensity distribution on the second position adjustment optical structure with the first position adjustment optical structure; and
changing, in accordance with the position of the second light diffraction element with respect to the first light diffraction element, the intensity distribution of the formed optical image with the second position adjustment optical structure.

3. The method according to claim 2, wherein the second position adjustment optical structure includes a microcell that blocks the adjustment signal light and that transmits computation signal light.

4. The method according to claim 1, further comprising:
forming the first position adjustment optical structure inside the first computing optical structure; and
forming the second position adjustment optical structure inside the second computing optical structure.

5. The method according to claim 4 further comprising:
forming the first position adjustment optical structure in a peripheral portion of the first computing optical structure; and
forming the second position adjustment optical structure in a peripheral portion of the second computing optical structure.

6. A light diffraction element comprising:
a computing optical structure constituted by microcells; and
a position adjustment optical structure inside or outside the computing optical structure.

7. An optical computing device comprising:
two or more light diffraction elements, each of which is the light diffraction element according to claim 6.
